(19) United States
(12) Patent Application Publication
(10) Pub. No.: US 2006/0096478 A1
(43) Pub. Date: May 11, 2006

(54) Printing machine with extensible print cylinder for easy change of the print sleeve

(76) Inventor: Giorgio Marchini, Segrate MI (IT)

Correspondence Address: LUCAS & MERCANTI, LLP, 475 PARK AVENUE SOUTH, 15TH FLOOR, NEW YORK, NY, 10016, US

(21) Appl. No.: 10/534,556

(22) PCT Filed: Aug. 25, 2003
(86) PCT No.: PCT/IT03/00516

§ 371 Date: May 9, 2005

(51) Int. Cl. B41F 13/10

(52) U.S. Cl. 101/375

(57) ABSTRACT

A printing machine to work corrugated board and the like includes a print cylinder provided with radial holes (E, E′) for emitting compressed air in order to allow the introduction and removal of a print sleeve (S) carrying a print cliché (C), said print cylinder consisting of a fixed shaft (F) on which there is airtightly slidably mounted a mobile cylinder (M) carrying said print sleeve (S), the print cylinder being supported at one end by a dismountable flange with a removable part (R) and by a piston (L) suitable to engage a corresponding seat so to allow the axial movement of said mobile cylinder (M) between a retracted work position and an extended sleeve change position, in which it projects through the machine side to make the change easier, simply by means of the same compressed air used to replace the print sleeve (S).

The present invention relates to printing machines, and in particular to a printing machine with extensible print cylinder.

It is known that in the last years in flexographic and rotogravure printing machines the technology of the so-called “print sleeve” has become widespread, which sleeve is in practice a light cylinder (usually made of composite material) on which the print cliché is secured, whereafter the print sleeve is slipped onto the real print cylinder. In this way the replacement of the cliché can take place offline, thus reducing to a minimum the down time of the machine since the replacement of the sleeve on the print cylinder is much simpler and faster than that of the cliché (which requires a very precise positioning for a suitable print quality).

In fact the sleeve is merely slipped onto the cylinder with the aid of compressed air which comes out of radial holes in the cylinder, so as to slightly expand the sleeve and to make easier the introduction thereof. Once the sleeve has been positioned, the locking is achieved automatically by cutting off the flow of compressed air since the sleeve has an inner diameter in interference with the cylinder, i.e. slightly smaller than the outer diameter of the cylinder.

To carry out the sleeve replacement it is therefore necessary for the operator to access a free end of the print cylinder; at this end the sleeve being used is removed from the cylinder and still at this same end the replacement sleeve is slipped onto the cylinder.

However this technology can not be plainly transferred to the field of the machines for working corrugated board and the like (so-called printer slotter, casemaker, or rotary dinker), because the access to the free end of the cylinder to replace the sleeve is a problem.

In fact in these machines the operator cannot easily reach the end of the cylinder because the side of the machine has a thickness of 400-600 mm due to the space taken up by the internal mechanisms. Moreover, the room for access is quite limited by the presence of these mechanisms, and it also implies a certain risk for the operator who must introduce his arms among the mechanisms and operate in a quite uncomfortable position and practically blindly.

Therefore the object of the present invention is to provide a printing machine which is free from said drawbacks. This object is achieved by means of a printing machine provided with means for longitudinally extending the print cylinder. Other advantageous features of the present machine are disclosed in the subsequent claims.

The main advantage of the present machine stems from the ease with which the operator can carry out the sleeve replacement, since the cylinder extends towards him through the machine side rather than being he who must introduce his arms in the machine. As a consequence the replacement operation is much easier, faster and safer.

Another significant advantage of this machine stems from the fact that the extension of the cylinder is preferably achieved through a very simple structure by using the same compressed air circuit which already provides the expansion of the sleeve. As a consequence this capacity of the machine does not imply a much greater structural complexity, which positively affects the cost and reliability.

Further advantages and characteristics of the machine according to the present invention will be clear to those skilled in the art from the following detailed description of an embodiment thereof, with reference to the annexed drawings wherein:

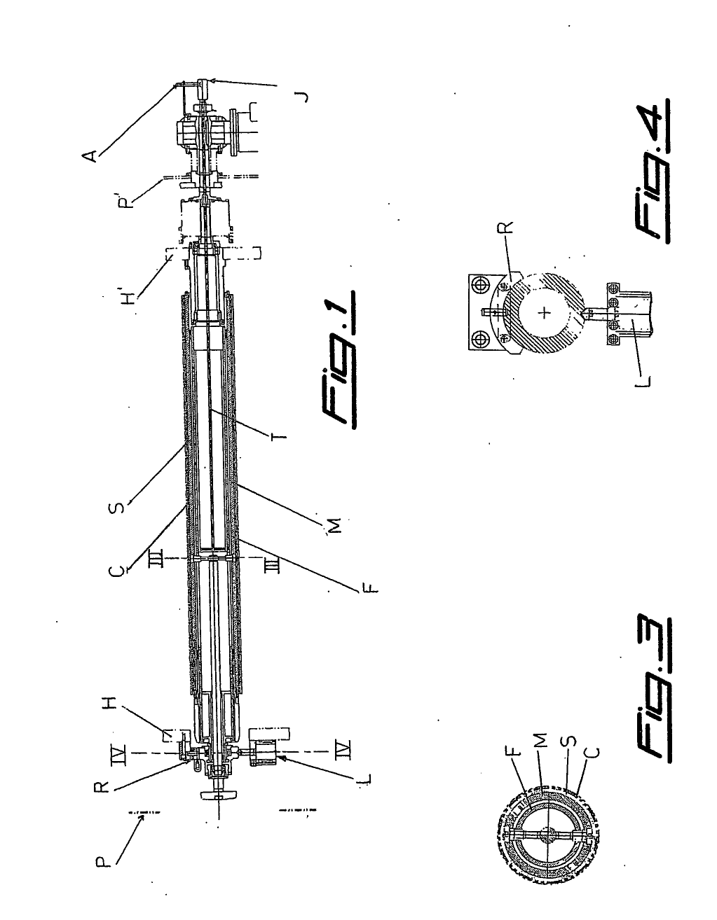

FIG. 1 is a longitudinal sectional view of the print cylinder in the work position;

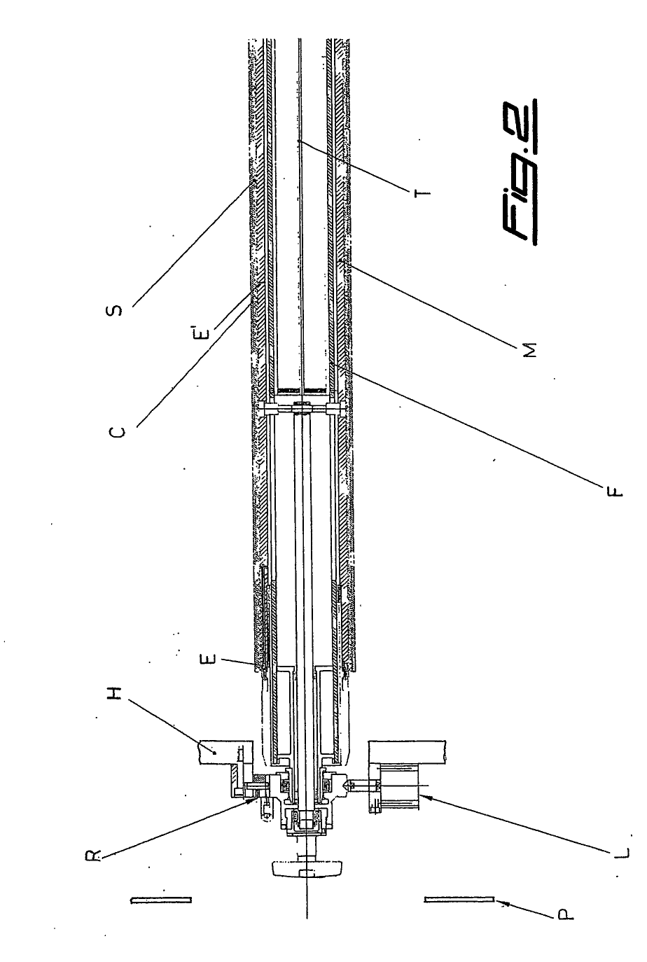

FIG. 2 is a partial enlarged view of FIG. 1, showing in greater detail the structure of the mobile portion of the cylinder;

FIG. 3 is a cross-sectional view along the line III-III of FIG. 1;

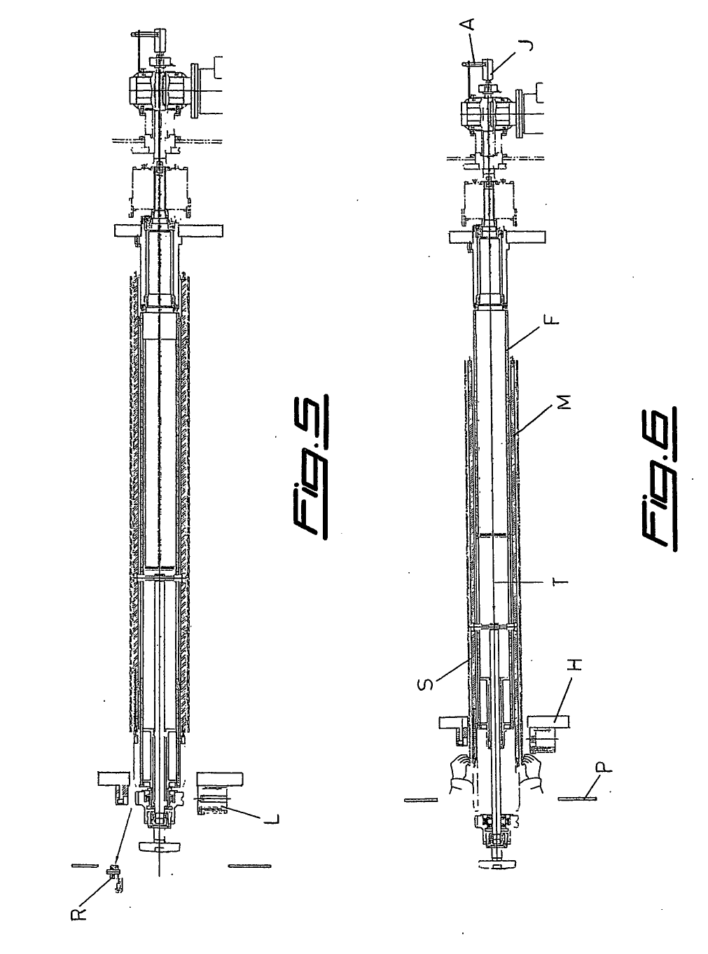

FIG. 4 is a cross-sectional view along the line IV-IV of FIG. 1;

FIG. 5 is a view similar to FIG. 1 of the cylinder in the unlocking phase to start the replacement;

FIG. 6 is a view similar to FIG. 1 of the extended cylinder in the position where the operator can grab the print sleeve; and

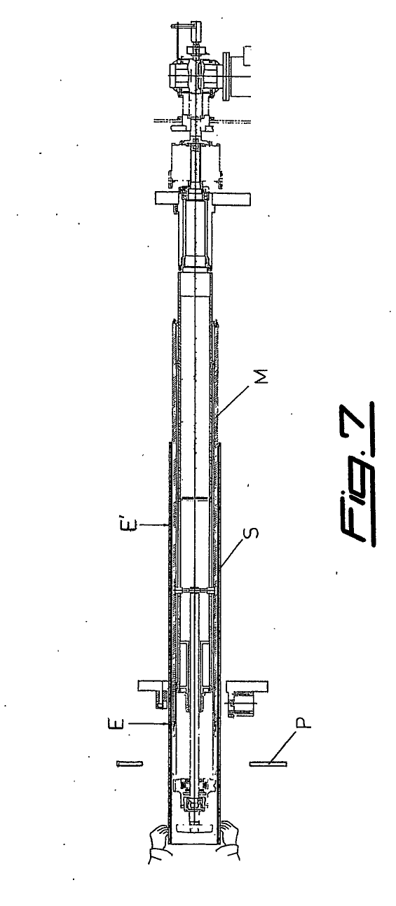

FIG. 7 is a view similar to FIG. 1 of the extended cylinder with the sleeve being removed.

With reference to FIGS. 1 to 4, there is seen that in a machine according to the present invention the print cylinder is contained between flanks H, H′ with the right flank H′ which rigidly supports an internal fixed shaft F on which there is airtightly slidably mounted a mobile cylinder M. Beyond the right flank H′ there are arranged the drive members, a protective casing P′ and a tube A for the delivery of compressed air which feeds the air to an axial duct T through a relevant rotating joint J.

Through subsequent branches of duct T, the air reaches two series of radial holes E, E′ through which it comes out to allow the replacement of sleeve S carrying the cliché C, as previously explained.

The left flank H supports the left end of the print cylinder through a dismountable flange with a removable part R, the cylinder being also locked from below by a piston L which engages a corresponding seat. Beyond the left flank H there is also arranged the knob for the fine adjustment of the centering of the print image in the direction perpendicular to the sheet travel, which knob is accessed through an opening in the protective casing P which is the same opening used to allow the extension of the cylinder.

The simple and effective operation of the present machine is now illustrated with reference also to FIGS. 5 to 7.

Starting from the work condition illustrated in FIG. 1, when sleeve S has to be replaced first the left support is released, by retracting the bottom piston L and removing the top semiflange R (FIG. 5).

The extension of the print cylinder is then achieved by feeding compressed air through tube A, joint J and duct T whereby the mobile portion M slides on the fixed shaft F. In this way the end portion of the cylinder comes out through flank H and casing P, and the end of sleeve S can be easily reached by the hands of the operator since it is more or less in the position previously occupied by the adjustment knob (FIG. 6).

At the end of the preceding phase, the air pressure inside the print cylinder will have reached such a value as to allow the outflow of air through the relevant holes E, E′ causing an expansion of sleeve S. Therefore the operator can now effortlessly remove sleeve S from the cylinder and replace it with another sleeve previously prepared with the relevant cliché (FIG. 7).

Once the new sleeve S is slipped onto the mobile cylinder M for its whole length, still with the aid of the compressed air which continues to come out of the holes, the supply of compressed air is cut off so as to achieve the locking of the sleeve on the cylinder.

The pressure inside the print cylinder is then discharged, so that the mobile part M is free to slide on the fixed shaft F. The operator can thus put it back in position by pushing it inside the machine simply by acting on the knob at the left end.

When the print cylinder is in position, the left support is re-assembled by reinstalling the top semiflange R and by locking with piston L from below.

It is clear that the above-described and illustrated embodiment of the machine according to the invention is just an example susceptible of various modifications. In particular, the releasable means which support the free end of the cylinder may be different from the removable semiflange R and the locking piston L, for example two or more pistons or other locking means which can be retracted to allow the extension of the cylinder.

Similarly, the extension of the cylinder may be achieved through means different from compressed air, such as an axial pusher, a wormscrew or the like.

1. Printing machine including a print cylinder provided with radial holes (E, E′) for emitting compressed air in order to allow the introduction and removal of a print sleeve (S) carrying a print cliché (C), characterized in that said print cylinder consists of a fixed shaft (F) on which there is slidably mounted a mobile cylinder (M) carrying said print sleeve (S), in that the print cylinder is supported at one end by releasable support means suitable to allow the axial movement of said mobile cylinder (M), and in that it includes means for axially moving the mobile cylinder (M) between a retracted work position and an extended sleeve change position in which it projects through the machine side.

2. Printing machine according to claim 1, characterized in that the mobile cylinder (M) is airtightly slidably mounted on the fixed shaft (F) and its axial movement is achieved by means of the same compressed air used to replace the print sleeve (S).

3. Printing machine according to claim 1, characterized in that the releasable support means consist of a dismountable flange with a removable part (R), and of a piston (L) suitable to engage a corresponding seat in the cylinder.

4. Printing machine according to claim 2, characterized in that the releasable support means consist of a dismountable flange with a removable part (R), and of a piston (L) suitable to engage a corresponding seat in the cylinder.
